(19) United States
(12) Patent Application Publication
(10) Pub. No.: US 2005/0205794 A1
(43) Pub. Date: Sep. 22, 2005

(54) Radioactivity measuring apparatus adaptable to shape of surface to be measured

(76) Inventors: Yasuhisa Ito, Naka-gun (JP); Hisashi Ishikawa, Naka-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/059,550

(22) Filed: Feb. 17, 2005

(30) Foreign Application Priority Data
Feb. 27, 2004 (JP) 2004-54923

(51) Int. Cl. G01T 1/20

(52) U.S. Cl. 250/367

(57) ABSTRACT

An apparatus is provided which is capable of directly and efficiently measuring surface contamination of objects to be measured having curved surfaces such as inner and outer surfaces of pipes without the need for cutting pipes, etc. This radioactivity measuring apparatus comprises a radioactivity detection section 10 and a radioactivity measuring section 12 arranged separately and connected together via cables 14. The radioactivity detection section has a structure in which a plurality of elongated plate-shaped radioactivity detection units 16 are arranged in the width direction and connected together in a detachable manner using connecting fittings 18. Each of the connecting fittings is formed in such a way that it is bent at angles between surfaces of parts thereof on which the respective radioactivity detection units are mounted corresponding to the shape of the surface to be measured. Using the connecting fittings having different angles between mounting surfaces allows flat surfaces or even curved surfaces with arbitrary curvatures to be measured in conformity with the shape of the surface.

### FIELD OF THE INVENTION

The present invention relates to a radioactivity measuring apparatus adaptable to objects to be measured having a variety of curved surfaces. More specifically, the present invention relates to a radioactivity measuring apparatus comprising a plurality of elongated plate-shaped radioactivity detection units arranged in the width direction and connected together using connecting fittings, each of which is formed in such a way that it is bent at angles between surfaces of parts thereof on which the respective radioactivity detection units are mounted corresponding to the shape of the surface to be measured, thereby constructing a radiation detection section so as to be adaptable to a variety of shapes of surfaces to be measured such as curved surfaces with different curvatures.

### BACKGROUND OF THE INVENTION

Nuclear power related facilities, etc., produce many articles to be taken out and waste of various shapes. The former includes apparatuses, equipment, scaffolding, etc. which were used in a controlled area, and the latter includes waste produced when the aging facilities are remodeled or dismantled. It is mandatory to classify these articles and waste according to their radioactivity levels so that they are subjected to predetermined processing such as disposal or storage. For this purpose, the presence/absence and the level of radioactive contamination of waste are measured using various radioactivity measuring apparatuses. In this case, a radioactivity measuring apparatus (a surface contamination survey meter) is widely used to measure surface contamination by measuring the entire surface of an object to be measured.

Most of conventional surface contamination survey meters have a flat detection surface. Therefore, when the surface of an object to be measured is flat (plank, etc.), there is no big problem, but in the case of curved surfaces (pipes and drums, etc.), measurements take time and trouble or there are cases where measurements are even not possible. Therefore, when the object to be measured has a curved surface such as a cylindrical shape, and when measuring α-rays having a short range in particular, a method of remodeling the detection surface into a shape conforming to the shape of the surface to be measured has been adopted so far. For example, Japanese Patent Laid-Open Specification No. 9-159769/1997 discloses an example of changing the shape of a detection surface according to the object to be measured.

However, even if a conventional surface contamination survey meter remodels the detection surface in conformity with the shape of the object to be measured, it cannot handle different objects to be measured and it is necessary to prepare many types of surface contamination survey meters having a variety of shapes of detection surfaces, which is not realistic. Therefore, in measurements of waste, etc., the object to be measured is cut (e.g., a pipe is cut longitudinally) in most cases so as to make the shape of the detection surface flat to facilitate measurements and enable measurements.

### SUMMARY OF THE INVENTION

The problems to be solved by the present invention include problems that the conventional system is unable to directly measure surface contamination of objects to be measured having curved surfaces such as inner or outer surfaces of pipes without cutting pipes longitudinally, thus taking time in preprocessing and measurements, which results in very poor efficiency in survey work.

According to the present invention, there is provided a radioactivity measuring apparatus adaptable to the shape of a surface to be measured, comprising a radioactivity detection section and a radioactivity measuring section arranged separately and connected together via cables, wherein the radioactivity detection section has a structure in which a plurality of elongated plate-shaped radioactivity detection units are arranged in the width direction and connected together in a detachable manner using connecting fittings, each of the connecting fittings being formed in such a way that it is bent at angles between surfaces of parts thereof on which the respective radioactivity detection units are mounted corresponding to the shape of the surface to be measured.

Here, each of the connecting fittings preferably has a structure in which holes and/or notches for insertion of screws are formed in a strip metal sheet which is bent at necessary angles between the mounting surfaces, the connecting fittings being fixed by screws at two locations on the front end side and base end side of the respective radioactivity detection units. When the shape of the surface to be measured is flat, the connecting fitting has a plate-shape. When the shape of the surface to be measured is curved surface, the connecting fitting is bent at a predetermined angle at a position between the neighboring mounting surfaces.

Since the radioactivity measuring apparatus according to the present invention has the radioactivity detection section with a plurality of elongated plate-shaped radioactivity detection units connected in the width direction using connecting fittings, it is possible to select connecting fittings having necessary angles between mounting surfaces and thereby arrange and hold the respective radioactivity detection units according to the surface shape of the object to be measured even in the case of inner or outer surfaces of pipes and drums having different diameters. Therefore, it is possible to directly measure surface contamination on inner or outer surfaces of pipes and drums having different diameters. Furthermore, since no preprocessing such as longitudinal cutting of pipes for measurements is required, it is also possible to significantly improve the efficiency in overall survey work.

The respective radioactivity detection units used in the present invention have an elongated, plate-shape and can have a flat detection surface, and consequently a commercially available radiation source can be used as a standard radiation source for calibration. Therefore, while being a radioactivity measuring apparatus adaptable to various curved surfaces, it can be easily calibrated using a radiation source in a procedure similar to that for a general surface contamination survey meter.

### BRIEF DESCRIPTION OF THE DRAWINGS

FIG. 1 is a conceptual diagram showing a radioactivity measuring apparatus according to the present invention.

FIGS. 2A, 2B and 2C illustrate an example of a radioactivity detection section used in the present invention.

FIG. 2D is a plan view of an example of a connecting fitting used in the example shown in FIG. 2A.

FIGS. 3A to 3C illustrate examples of connecting fittings.

FIGS. 4A to 4F illustrate examples of situations when an outer surface and inner surface of a tube are measured.

### PREFERRED EMBODIMENTS OF THE INVENTION

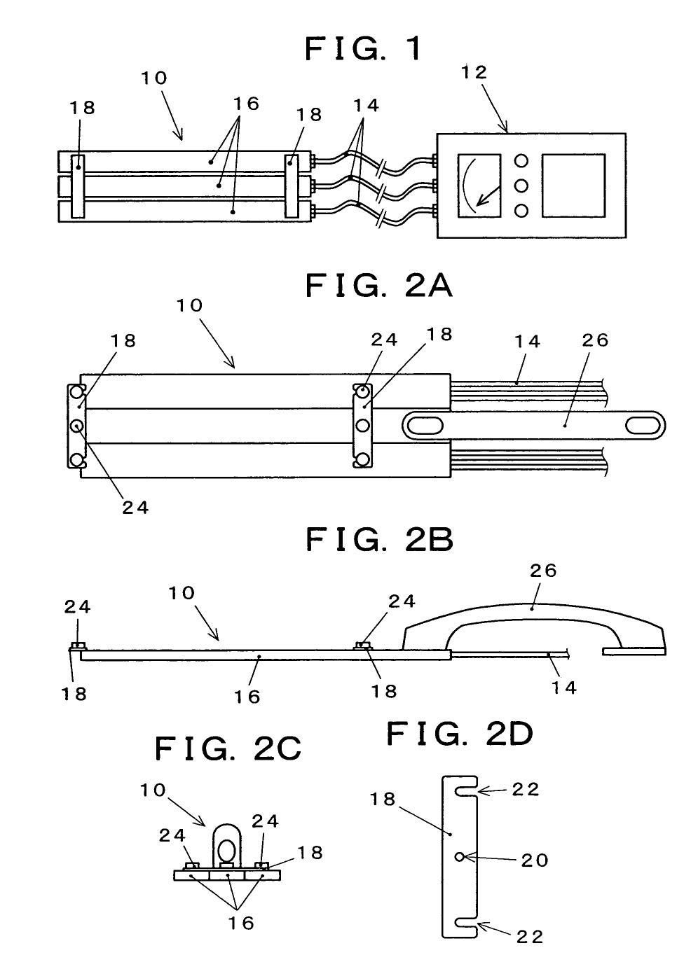

As shown in FIG. 1, the radioactivity measuring apparatus of the present invention combines a radioactivity detection section 10 and a radioactivity measuring section 12 as independent bodies, which are connected together using cables 14 so that measurement signals of α-rays detected by the radioactivity detection section 10 are transmitted to and measured by the radioactivity measuring section 12. According to the present invention, the radioactivity detection section 10 has a structure in which a plurality of elongated plate-shaped radioactivity detection units 16 are arranged in the width direction thereof and connected together in a detachable manner using connecting fittings 18. Each of these connecting fittings 18 is formed in such a way that it is bent at angles between surfaces of parts thereof on which the respective radioactivity detection units 16 are mounted (in the present invention, referred to as “angles between mounting surfaces”) corresponding to the shape of the surface to be measured. Therefore, the most important feature of the present invention is that it is applicable to various measurements from measurement of a flat surface (angles between mounting surfaces=180 degrees) to measurement of a curved surface with an arbitrary curvature by using (replacing) arbitrary connecting fittings having different angles between mounting surfaces or different spaces between mounting sections.

The radioactivity measuring apparatus can have an arbitrary structure, but preferably combines a radioactivity detection section provided with a scintillator and a radioactivity measuring section provided with a photomultiplier, both of which are connected together using wavelength conversion optical fiber cables so that a measurement signal (optical signal) of α-rays detected by the radioactivity detection section is directly transmitted to the radioactivity measuring section using the optical fiber cables. This is because this structure allows the relatively bulky photomultiplier to be incorporated in the radioactivity measuring section, making it possible to design the shape of the radioactivity detection unit relatively freely and thereby drastically reduce the size and make the apparatus more elongated and thinner (e.g., a thickness of approximately 10 mm or less). For this purpose, an array structure using connecting fittings is particularly effective and it is possible to easily measure contamination on inner and outer surfaces of objects to be measured of a curved shape such as pipes and drums.

FIGS. 2A to 2C illustrate an example of the radioactivity detection section used in the present invention. FIG. 2A shows a plan view, FIG. 2B shows a front view, and FIG. 2C shows a side view. Further, FIG. 2D shows a detailed view of a connecting fitting used in this example. The radioactivity detection section 10 is constructed of a plurality (3 in this example) of elongated plate-shaped radioactivity detection units 16 arranged in the width direction and connected together using connecting fittings 18 to thereby form a integral structure. Each of the radioactivity detection units 16 is provided with a scintillator

Each of the connecting fittings 18 is formed so that angles between mounting surfaces correspond or conform to the shape of the surface to be measured (180 degrees, that is, plate-shape in this example). As shown in FIG. 2D, this connecting fitting 18 has a screw insertion hole 20 in the center and screw insertion notches 22 at both ends of a strip metal sheet, so as to be fixed by screws 24 at two locations on the front end side and base end side of the respective radioactivity detection units 16. A screw tightening section is provided on the back of each radioactivity detection unit 16 and hand screws (driver-less screws) are passed through the screw insertion hole 20 and screw insertion notches 22 at both sides thereof and tightened so that the connecting fittings 18 and radioactivity detection units 16 can be easily connected. This structure provides an easy and quick way for assembling the radioactivity detection section.

The structure shown in FIGS. 2A to 2C is for measurement of a flat surface, and therefore the connecting fittings 18 have a plate-shape. A handle 26 is attached at a position close to the base end of any one of the radioactivity detection units (the radioactivity detection unit arranged in the center in this example) 16. By gripping the handle 26, the measurer can move the radioactivity detection section 10 along the surface to be measured smoothly and measure the object. Arranging a necessary number of radioactivity detection units 16 can easily increase the detection area.

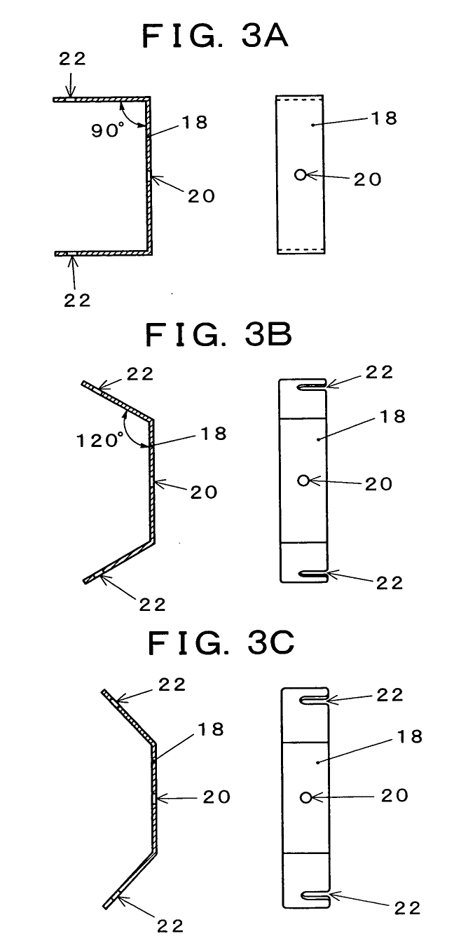

FIGS. 3A to 3C show other examples of the connecting fittings 18. FIG. 3A shows an example where the angles between mounting surfaces (bending angles) are set to 90 degrees, FIG. 3B shows an example where the angles between mounting surfaces (bending angles) are set to 120 degrees and FIG. 3C shows an example where the mounting surfaces are bent at larger degrees. In FIGS. 3A to 3C, figures on the right show plan views and figures on the left show sectional views of the respective connecting fittings. Providing a plurality of types of connecting fittings 18 with different bending angles and lengths corresponding to the shape of the surface to be measured can support various objects to be measured.

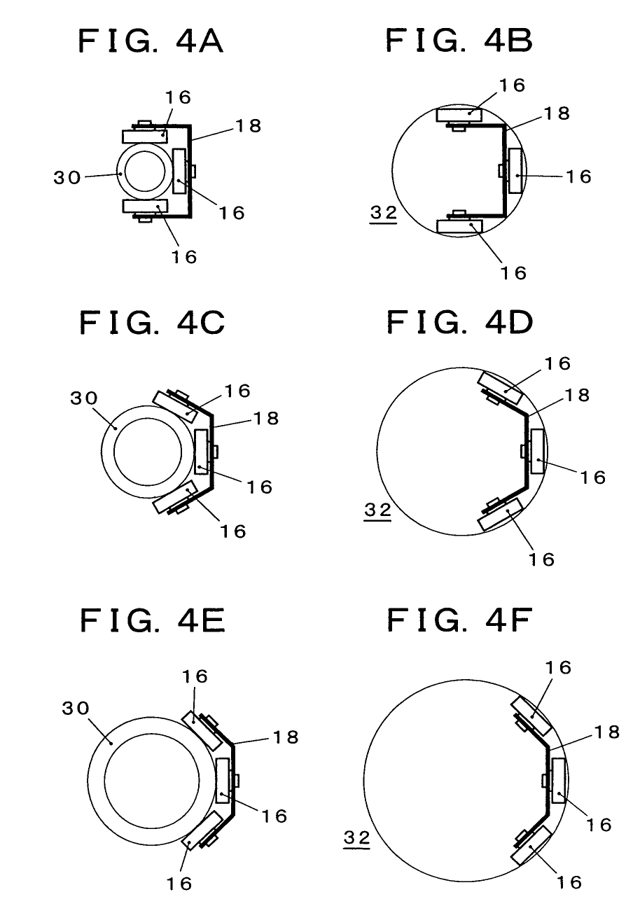

FIGS. 4A to 4F illustrate examples of measurement situations. When the radioactivity detection units 16 are attached inside the connecting fitting 18 bent or folded at a predetermined angle, it is possible to measure the outer surface of a pipe 30 (see FIGS. 4A, 4C and 4E) and when the radioactivity detection units 16 are attached outside the connecting fitting 18 bent or folded at a predetermined angle, it is possible to measure the inner surface of a pipe 32 (see FIGS. 4B, 4D and 4F).

As being understood from the foregoing, by replacing connecting fittings 18, it is possible to arrange the respective radioactivity detection units 16 along an arbitrary curved surface in close contact therewith, and measure inner or outer surfaces of pipes and drums of different diameters along the curved surfaces. This also allows efficient measurements of surface contamination of pipes, scaffolding pipes, drums and equipment, etc.

The above illustrated examples show the case where three radioactivity detection units are connected, but when the area of the detection surface should be widened (especially when measuring a flat surface), more radioactivity detection units can be connected. The bending angles of the connecting fittings may be freely set and the lengths thereof may also be changed as appropriate. With regard to the mounting structure, a method of tightening using screws is preferable but other methods using clamps, etc., may also be used. With regard to screw insertion holes and notches, only holes or only notches may be used, but using holes in the center and notches at both sides thereof can produce advantages of facilitating provisional holding with holes and detachment/attachment with notches.

In the respective radioactivity detection units of this example, α-rays emitted from a radioactivity material pass through a light-shielding film, reach a ZnS(Ag) scintillator layer and generate scintillation light. The scintillation light generated propagates directly or inside a light guide to reach a wavelength conversion optical fiber, is converted to a wavelength appropriate for photoreception or transmission, propagates through the wavelength conversion optical fiber, passes through the wavelength conversion optical fiber cable and reaches the photomultiplier of the radioactivity measuring section 12. The circuit structure for measuring radiation by the radioactivity measuring apparatus can be similar to that of a conventional apparatus.

1. A radioactivity measuring apparatus adaptable to the shape of a surface to be measured, comprising a radioactivity detection section and a radioactivity measuring section arranged separately and connected together via cables, wherein said radioactivity detection section has a structure in which a plurality of elongated plate-shaped radioactivity detection units are arranged in the width direction and connected together in a detachable manner using connecting fittings, each of said connecting fittings being formed in such a way that it is bent at angles between surfaces of parts thereof on which the respective radioactivity detection units are mounted corresponding to the shape of the surface to be measured.

2. The radioactivity measuring apparatus according to claim 1, wherein each of said connecting fittings has a structure in which holes and/or notches for insertion of screws are formed in a strip metal sheet which is bent at necessary angles between the mounting surfaces, said connecting fittings being fixed by screws at two locations on the front end side and base end side of the respective radioactivity detection units.
